(19) United States
(12) Patent Application Publication
(10) Pub. No.: US 2026/0126580 A1
(43) Pub. Date: May 7, 2026

(54) MULTICORE OPTICAL FIBER AND OPTICAL CABLE

(71) Applicant: SUMITOMO ELECTRIC INDUSTRIES, LTD., Osaka (JP)

(72) Inventors: Yuto KOBAYASHI, Osaka (JP); Takemi HASEGAWA, Osaka (JP)

(21) Appl. No.: 19/480,956

(22) PCT Filed: Feb. 21, 2025
(86) PCT No.: PCT/JP2025/006073

§ 371 Date: Nov. 3, 2025

(30) Foreign Application Priority Data
Mar. 6, 2024 (JP) 2024-034104

(51) Int. Cl. G02B 6/02

(52) U.S. Cl. CPC G02B 6/02042

(57) ABSTRACT

A multicore optical fiber includes a glass fiber. The glass fiber includes a plurality of cores extending along a central axis of the glass fiber and a first cladding surrounding the plurality of cores. The plurality of cores includes a first core and a second core that are closest to each other. An inequality of 250×10⁻⁶≤n1−n2≤950×10⁻⁶ is satisfied, where, at a wavelength that is at least one of wavelengths in a range of 1260 nm to 1625 nm, inclusive, n1 is an effective refractive index of the first core, and n2 is an effective refractive index of the second core. An inequality of d1−d2≤−0.1 μm is satisfied, where d1 is a mode field diameter of the first core at the wavelength and d2 is a mode field diameter of the second core at the wavelength.

### TECHNICAL FIELD

The present disclosure relates to a multicore optical fiber and an optical cable. This application claims priority based on Japanese Patent Application No. 2024-034104 filed on Mar. 6, 2024, the entire contents of which are incorporated herein by reference.

### BACKGROUND ART

In an uncoupled multicore optical fiber (hereinafter also referred to as “MCF”), it is an important matter to reduce inter-core crosstalk (hereinafter also referred to as “XT”). Patent literature 1 describes that heterogeneity is provided between cores in order to reduce XT. Patent literature 2 also describes that heterogeneity is provided between cores. Non-patent literature 1 describes that XT has the dependence on the bending radius in an MCF in which heterogeneity is provided between cores. Non-patent literature 2 describes an equation for calculating the peak position of the dependence of XT on the bending radius. Non-Patent Literature 3 describes that an MCF with heterogeneity between cores is manufactured and the dependence of XT on the bending radius is actually measured in the MCF.

### CITATION LIST

### Patent Literature

Patent literature 1: WO 2023/189621

Patent literature 2: U.S. Patent Application Publication No. 2024/0053530

### Non Patent Literature

Non-patent literature 1: Koshiba et al., “Analytical Expression of Average Power-Coupling Coefficients for Estimating Intercore Crosstalk in Multicore Fibers” October 2012, IEEE Photonics Journal Vol. 4, No. 5, pp. 1987-1995

Non-Patent Literature 2: Hayashi et al., “Physical interpretation of intercore crosstalk in multicore fiber: effects of macrobend, structure fluctuation, and microbend” 11 Mar. 2013, OPTICS EXPRESS Vol. 21, No. 5, pp. 5401-5412

Non-Patent Literature 3: Kobayashi et al., “Characterization of Inter-core Crosstalk of Multi-core Fiber as a Function of Bending Radius with Multi-channel OTDR” OECC/PSC 2022 TuC2-2

### SUMMARY OF INVENTION

An MCF according to one aspect of the present disclosure is an MCF including a glass fiber. The glass fiber includes a plurality of cores extending along a central axis of the glass fiber and a first cladding surrounding the plurality of cores. The plurality of cores includes a first core and a second core that are closest to each other. An inequality of 250×10⁻⁶≤n1−n2≤950×10⁻⁶ is satisfied, where, at a wavelength that is at least one of wavelengths in a range of 1260 nm to 1625 nm, inclusive, n1 is an effective refractive index of the first core, and n2 is an effective refractive index of the second core. An inequality of d1−d2≤−0.1 μm is satisfied, where d1 is a mode field diameter of the first core at the wavelength and d2 is a mode field diameter of the second core at the wavelength.

### BRIEF DESCRIPTION OF THE DRAWINGS

FIG. 1 is a graph showing dependence of XT of an MCF on the bending radius.

FIG. 2 is a graph showing effective refractive index difference dependence of XT at a bending radius of 300 mm.

FIG. 3 is a graph showing effective refractive index difference dependence of XT at a bending radius of 150 mm.

FIG. 4 is a graph showing MFD dependence of cutoff wavelength.

FIG. 5 is a graph showing a relationship between effective refractive index and cutoff wavelength.

FIG. 6 is a graph showing a relationship between difference in MFDs and difference in cutoff wavelengths.

FIG. 7 is a graph showing a relationship between difference in effective refractive indices and difference in MFDs when a difference in cutoff wavelengths is 100 nm.

FIG. 8 is a diagram showing a cross section and a refractive index distribution orthogonal to a central axis of an MCF according to an embodiment.

FIG. 9 is a diagram showing an optical cable according to an embodiment.

FIG. 10 is a diagram showing a cross section and a refractive index distribution orthogonal to a central axis of an MCF according to a first modification.

FIG. 11 is a diagram showing a cross section and a refractive index distribution orthogonal to a central axis of an MCF according to a second modification.

FIG. 12 is a diagram showing a cross section and a refractive index distribution orthogonal to a central axis of an MCF according to a third modification.

FIG. 13 is a diagram showing a cross section and a refractive index distribution orthogonal to a central axis of an MCF according to a fourth modification.

FIG. 14 is a diagram showing a cross section and a refractive index distribution orthogonal to a central axis of an MCF according to a fifth modification.

FIG. 15 is a diagram showing a cross section orthogonal to a central axis of an MCF according to a sixth modification.

FIG. 16 is a diagram showing a cross section orthogonal to a central axis of an MCF according to a seventh modification.

FIG. 17 is a diagram showing a cross section orthogonal to a central axis of an MCF according to an eighth modification.

FIG. 18 is a diagram showing a cross section orthogonal to a central axis of an MCF according to a ninth modification.

FIG. 19 is a diagram showing a cross section orthogonal to a central axis of an MCF according to a tenth modification.

### DETAILED DESCRIPTION

### Problems to be Solved by Present Disclosure

In an MCF in which heterogeneity is simply provided between cores, the XT reduction effect may fail to be obtained depending on a bending radius at which the MCF is used. When the heterogeneity between the cores is increased so as to obtain the XT reduction effect in consideration of a winding diameter of a bobbin, a difference in effective refractive indices of the fundamental modes between the cores increases. Thus, it is difficult to simultaneously satisfy the specifications of a cutoff and a bending loss, and the mass productivity is deteriorated. Hereinafter, unless otherwise specified, the “effective refractive index” means the “effective refractive index of the fundamental mode”.

### Advantageous Effects of Present Disclosure

The present disclosure provides an MCF and an optical cable capable of improving mass productivity while reducing XT.

### Description of Embodiments of Present Disclosure

The contents of the embodiments of the present disclosure are described. (1) An MCF according to one aspect of the present disclosure is an MCF including a glass fiber. The glass fiber includes a plurality of cores extending along a central axis of the glass fiber and a first cladding surrounding the plurality of cores. The plurality of cores includes a first core and a second core that are closest to each other. An inequality of 250×10⁻⁶≤n1−n2≤950×10⁻⁶ is satisfied, where, at a wavelength that is at least one of wavelengths in a range of 1260 nm to 1625 nm, inclusive, n1 is an effective refractive index of the first core, and n2 is an effective refractive index of the second core. An inequality of d1−d2≤−0.1 μm is satisfied, where d1 is a mode field diameter of the first core at the wavelength and d2 is a mode field diameter of the second core at the wavelength. In this MCF, since a difference in effective refractive indices between the first core and the second core is 250×10⁻⁶ or more, XT can be reduced. In addition, since a difference in mode field diameters between the first core and the second core is 0.1 μm or more and the difference in effective refractive indices of the first core and the second core is 950×10⁻⁶ or less, a difference in cutoff wavelengths between the first core and the second core can be set to 100 nm or less. Thus, the specifications of the cutoff and the bending loss can be satisfied simultaneously while reducing the XT.

(2) In the above (1), an inequality of n1−n2≥400×10⁻⁶ may be satisfied. An inequality of d1−d2≤−0.15 μm may be satisfied. In this case, the specifications of the cutoff and the bending loss can be satisfied simultaneously while further reducing the XT.

(3) In the above (2), an inequality of d1−d2≤−0.45 μm may be satisfied. In this case, the specifications of the cutoff and the bending loss can be satisfied simultaneously while further reducing the XT.

(4) In any one of the above (1) to (3), an inequality of d1−d2≥−1.4 μm may be satisfied. In this case, when the MCFs are connected to each other, the connection loss can be reduced.

(5) In any one of the above (1) to (4), the plurality of cores may be arranged in a square lattice pattern in a cross section orthogonal to the central axis. From the viewpoint of using different types of cores between adjacent cores, the core density can be increased by arranging the plurality of cores in a square lattice pattern.

(6) In any one of the above (1) to (4), the number of the plurality of cores may be two. In this case, the specifications of the cutoff and the bending loss can be satisfied simultaneously while reducing the XT between the two cores.

(7) In the above (5) or (6), the plurality of cores may be arranged such that a centroid of the plurality of cores as a whole is shifted from the central axis in the cross section orthogonal to the central axis. In this case, the plurality of cores can be identified.

(8) In the above (5) or (6), the glass fiber may further include a marker surrounded by the first cladding. The marker may have a refractive index different from a refractive index of the first cladding. In this case, the plurality of cores can be identified.

(9) In any one of the above (1) to (8), the glass fiber may further include a second cladding surrounding the first cladding. The second cladding may have a refractive index higher than the refractive index of the first cladding and lower than any of refractive indices of the plurality of cores. In this case, even when the effective cross-sectional area of the core is increased, the bending loss is less likely to deteriorate.

(10) In the above (9), the first cladding may be a common cladding that collectively surrounds the plurality of cores. In this case, since the first cladding is the common cladding, the core can be disposed near the central axis. Thus, when the MCFs are connected to each other, the positional deviation due to the rotational deviation is reduced. As a result, the connection loss can be reduced.

(11) In the above (9), the first cladding may include a plurality of individual claddings surrounding a respective one of the plurality of cores. In this case, the first cladding can be formed by a manufacturing method similar to that for a single-core optical fiber. Thus, the manufacturing cost can be reduced.

(12) In any one of the above (1) to (11), the glass fiber may further include a low-refractive-index portion having a refractive index lower than the refractive index of the first cladding. The low-refractive-index portion may be provided on a line segment connecting a central axis of the first core to a central axis of the second core in the cross section orthogonal to the central axis. In this case, the XT can be further reduced.

(13) An optical cable according to an aspect of the present disclosure includes a plurality of MCFs according to any one of the above (1) to (12), and an outer sheath that accommodates the plurality of MCFs. In this case, since the MCFs are provided, the specifications of the cutoff and the bending loss can be satisfied simultaneously while reducing the XT.

### Details of Embodiments of Present Disclosure

Specific examples of an MCF and an optical cable according to a present embodiment will be described with reference to the drawings as necessary. The present disclosure is not limited to these examples, but is indicated by the claims, and is intended to include all modifications within the meaning and scope equivalent to the claims. In the following description, the same elements are denoted by the same reference signs in the description of the drawings, and redundant description will be omitted.

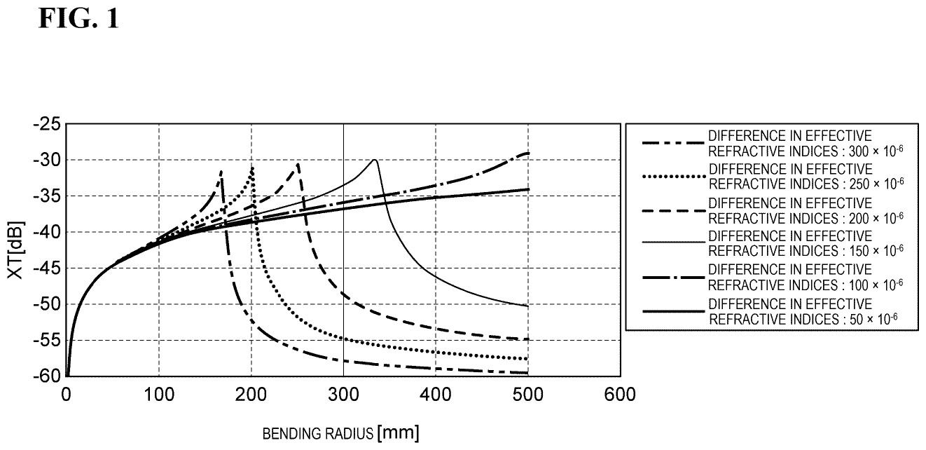

FIG. 1 is a graph showing dependence of XT of an MCF on the bending radius. The vertical axis of FIG. 1 indicates XT [dB] between cores that are closest to each other (hereinafter also referred to as “adjacent cores”) among the plurality of cores of the MCF. The horizontal axis of FIG. 1 indicates bending radius (bending diameter) [mm] of the MCF. FIG. 1 shows the dependence of the XT between adjacent cores on the bending radius when the difference in effective refractive indices (absolute values) between the adjacent cores at a desired wavelength at which XT is to be reduced is 300×10⁻⁶, 250×10⁻⁶, 200×10⁻⁶, 150×10⁻⁶, 100×10⁻⁶, or 50×10⁻⁶. Here, a core center-center distance between adjacent cores is 35 μm. The wavelength is 1550 nm.

The desired wavelength is, for example, at least one wavelength in a range of 1260 nm to 1625 nm. The desired wavelength may be at least one wavelength in the range of 1260 nm to 1360 nm, and may in particular be 1310 nm. The desired wavelength may be at least one wavelength in the range of 1530 nm to 1565 nm, and may in particular be 1550 nm. When single mode property is taken into consideration, the cutoff wavelengths of the adjacent cores may be shorter than the desired wavelength. In general, XT has wavelength dependence, but the peak of the bending radius of XT hardly depends on the wavelength. Thus, similar effect can be obtained at any wavelength within the above wavelength range.

An optical fiber is usually accommodated within a cable. It is known that a bending radius of the optical fiber inside the cable is about 300 mm. As shown in FIG. 1, XT has dependence on the bending radius. The XT increases as the bending radius increases from zero, and after reaching a peak (maximum value) at a predetermined bending radius R_pk, the XT decreases as the bending radius increases. The value of R_pk increases as the difference in effective refractive indices decreases. In a state where the heterogeneity between the cores is low (that is, a state where the difference in effective refractive indices is small), the value of R_pk is equal to or larger than the bending radius in the cable, and thus the XT reduction effect is small. The present inventors have found that the difference in effective refractive indices needs to be 250×10⁻⁶ or more in order to obtain a sufficient XT reduction effect.

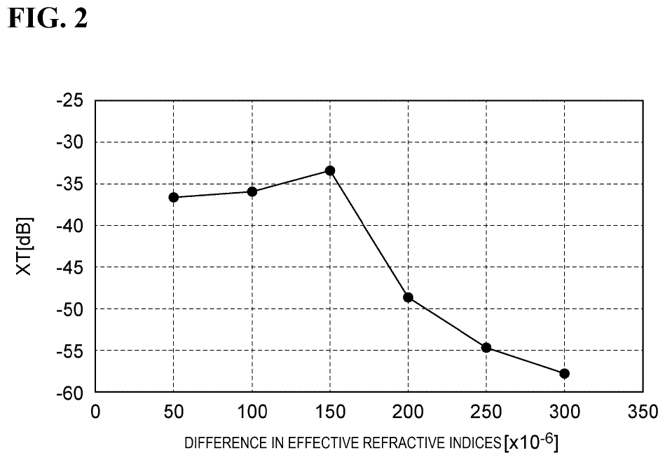

FIG. 2 is a graph showing effective refractive index difference dependence of XT at a bending radius of 300 mm. That is, FIG. 2 shows a relationship between the XT between adjacent cores and difference in effective refractive indices between the adjacent cores when the bending radius of the MCF is set to 300 mm. The vertical axis of FIG. 2 indicates XT [dB] between the adjacent cores. The horizontal axis of FIG. 2 indicates the difference in effective refractive indices [×10⁻⁶] between adjacent cores. As shown in FIG. 2, the XT starts to decrease significantly when the difference in effective refractive indices exceeds 150×10⁻⁶. At the difference in effective refractive indices of 250×10⁻⁶, the XT also improves by 20 dB relative to the difference in the effective refractive indices of 150×10⁻⁶.

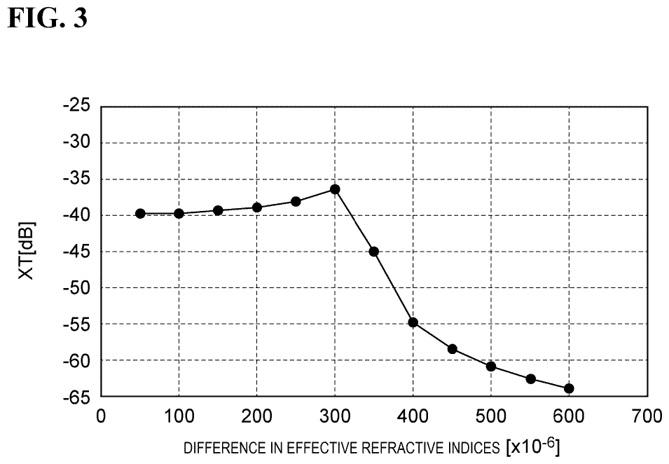

FIG. 3 is a graph showing effective refractive index difference dependence of XT at a bending radius of 150 mm. That is, FIG. 3 shows a relationship between the XT between adjacent cores and difference in effective refractive indices between the adjacent cores when the bending radius of the MCF is set to 150 mm. The vertical axis of FIG. 3 indicates XT [dB]. The horizontal axis of FIG. 3 indicates difference in effective refractive indices [×10⁻⁶]. Depending on the internal structure of the cable, the bending radius of the optical fiber inside the cable may be about 150 mm. In this case, as shown in FIG. 3, the difference in effective refractive indices needs to be 400×10⁻⁶ or more. By setting the difference in effective refractive indices to 400×10⁻⁶ or more, it is possible to be adopted in any cable structures.

When the difference in the effective refractive indices between the cores is increased, the difference in confinement ability between the cores is increased. This increases the difference (absolute value) in cutoff wavelengths between the cores. Here, among the adjacent cores, a core having a higher effective refractive index and a longer cutoff wavelength is referred to as a first core, and a core having a lower effective refractive index and a shorter cutoff wavelength is referred to as a second core. Under the condition that the difference in the cutoff wavelengths between the cores is large, when the cutoff wavelength of the first core is reduced to be equal to or less than used wavelength band, the cutoff wavelength of the second core becomes too short, and the bending loss of the second core increases, with the result that the second core impossible to withstand practical use. Thus, it is necessary to reduce the difference in cutoff wavelengths.

The present inventors have found that the difference in cutoff wavelengths can be reduced while maintaining the difference in effective refractive indices by making a difference in mode field diameters (hereinafter also referred to as “MFD”) between the adjacent cores. Specifically, an MFD of the first core is decreased, and an MFD of the second core is increased. By increasing the MFD while fixing the effective refractive index of the fundamental mode (LP01 mode) of the core, the effective refractive index of the lowest higher-order mode (LP11 mode) can be increased. This makes it possible to increase the cutoff wavelength.

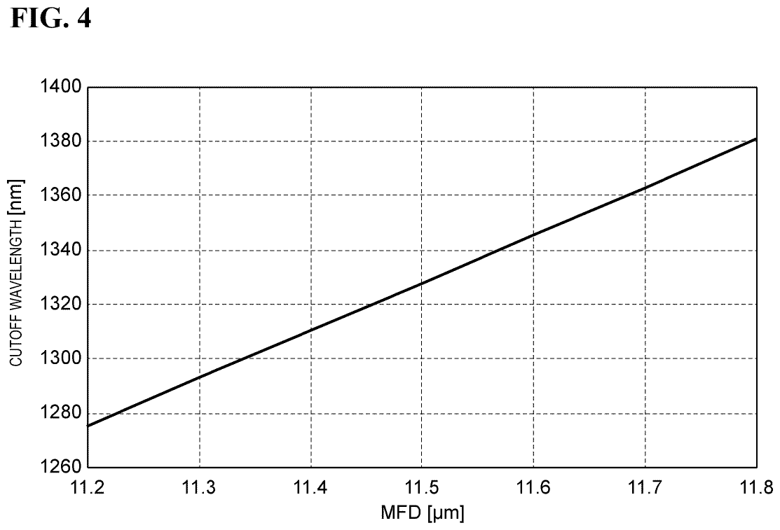

FIG. 4 is a graph showing MFD dependence of cutoff wavelength. The vertical axis of FIG. 4 indicates the cutoff wavelength [nm] when the effective refractive index of fundamental mode is 1.4416. The horizontal axis of FIG. 4 indicates MFD [μm]. It can be seen from FIG. 4 that as the MFD increases, the cutoff wavelength increases because the effective refractive index of the lowest higher-order mode increases. Thus, it is understood that, in order to reduce the difference in cutoff wavelengths between the first core and the second core, it is only necessary to shorten the cutoff wavelength of the first core by reducing the MFD of the first core, and to lengthen the cutoff wavelength of the second core by increasing the MFD of the second core.

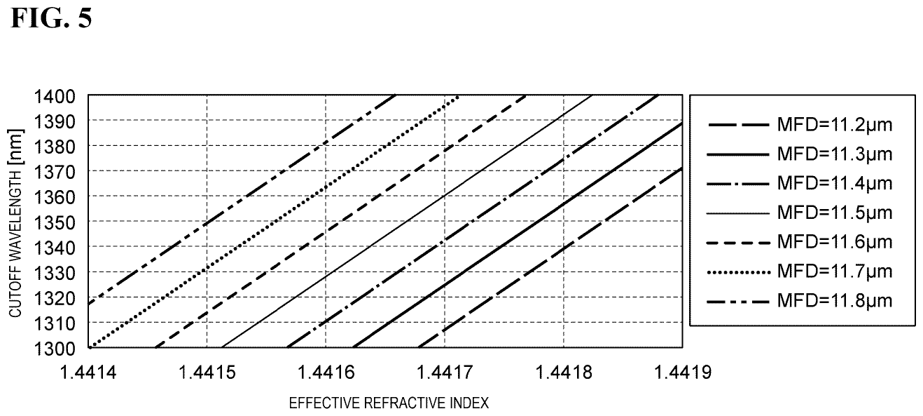

FIG. 5 is a graph showing a relationship between effective refractive index and cutoff wavelength. The vertical axis of FIG. 5 indicates cutoff wavelength [nm], and the horizontal axis of FIG. 5 indicates effective refractive index. FIG. 5 shows the relationship when the MFD is 11.2 μm, 11.3 μm, 11.4 μm, 11.5 μm, 11.6 μm, 11.7 μm or 11.8 μm. For example, a case where an effective refractive index of the first core is set to 1.4418 and an effective refractive index of the second core is set to 1.44155 in order to set the difference in effective refractive indices to 250×10⁻⁶ is considered. For example, when the MFDs of the first core and the second core are the same, i.e., 11.5 μm, the difference in cutoff wavelengths is about 80 nm. In contrast, when the MFD of the first core is 11.2 μm and the MFD of the second core is 11.5 μm, the difference in cutoff wavelengths is improved to about 30 nm.

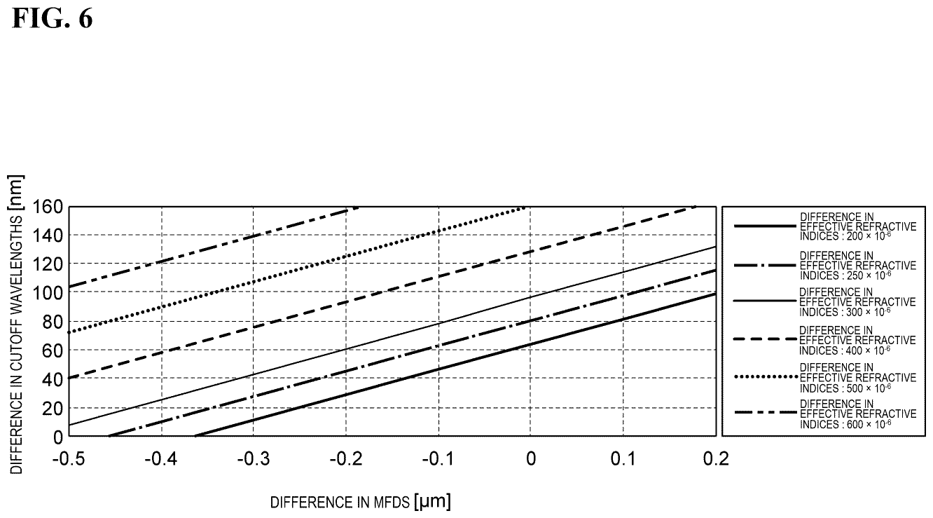

FIG. 6 is a graph showing a relationship between difference in MFDs and difference in cutoff wavelengths. The vertical axis of FIG. 6 indicates difference in cutoff wavelengths [nm] between adjacent cores (=“cutoff wavelength of first core”−“cutoff wavelength of second core”) is shown. The horizontal axis of FIG. 6 indicates the difference in MFDs between the adjacent cores (=“MFD of first core”−“MFD of second core”) [μm]. FIG. 6 shows the relationship when the difference in effective refractive indices between adjacent cores is 200×10⁻⁶, 250×10⁻⁶, 300×10⁻⁶, 400×10⁻⁶, 500×10⁻⁶, or 600×10⁻⁶.

In consideration of mass productivity, the difference in cutoff wavelengths needs to be 100 nm or less. When the difference in the cutoff wavelengths exceeds 100 nm, the cutoff wavelength of each core is difficult to be within a predetermined range, and the yield is reduced. The difference in the cutoff wavelengths may be 50 nm or less. This further improves the mass productivity.

It is understood from FIG. 6 that when the difference in effective refractive indices between the adjacent cores is 250×10⁻⁶, the difference in cutoff wavelengths can be made 50 nm or less by making the difference in MFDs between the adjacent cores (=“MFD of first core”−“MFD of second core”)−0.17 μm or less. It is understood that when the difference in the effective refractive indices between the adjacent cores is 400×10⁻⁶, the difference in cutoff wavelengths can be made 100 nm or less by making the difference in MFDs between the adjacent cores −0.15 μm or less, and the difference in the cutoff wavelengths can be made 50 nm or less by making the difference in the MFDs between the adjacent cores −0.45 μm or less.

In accordance with ITU-T G. 654, which is an international standard for a single-core optical fiber, the MFD tolerance of a single-core optical fiber is ±0.7 μm. Although there is no international standard such as ITU-T for an MCF, assuming that similar standard to that of the single-core optical fiber is applied, the difference in MFDs (=“MFD of first core”−“MFD of second core”) may be −1.4 μm or more.

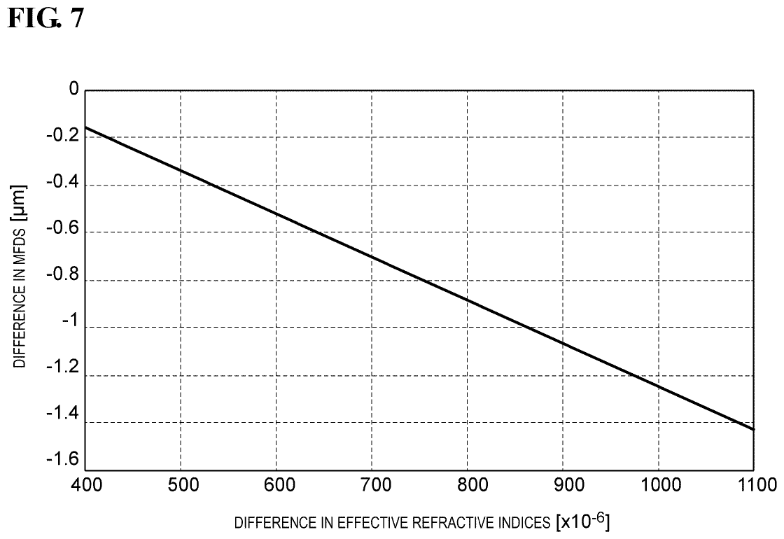

FIG. 7 is a graph showing a relationship between difference in effective refractive indices and difference in MFDs when a difference in cutoff wavelengths is 100 nm. The vertical axis of FIG. 7 indicates difference in MFDs between the adjacent cores [μm] (=“MFD of first core”−“MFD of second core”). The horizontal axis of FIG. 7 indicates difference in effective refractive indices between adjacent cores (=“effective refractive index of first core”−“effective refractive index of second core”) [×10⁻⁶]. It is understood from FIG. 7 that the difference in effective refractive indices may be 1100×10⁻⁶ or less. From FIG. 7, the difference in effective refractive indices may be 1080×10⁻⁶ or less.

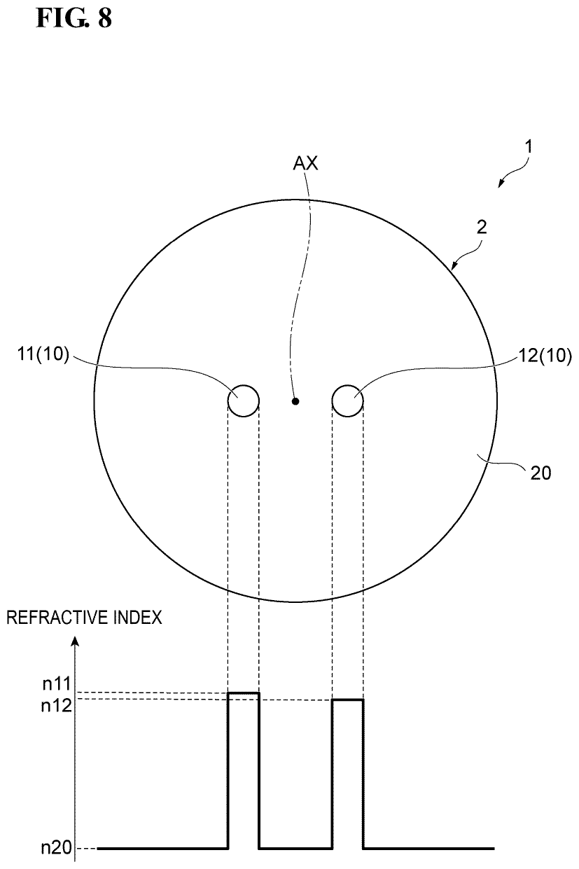

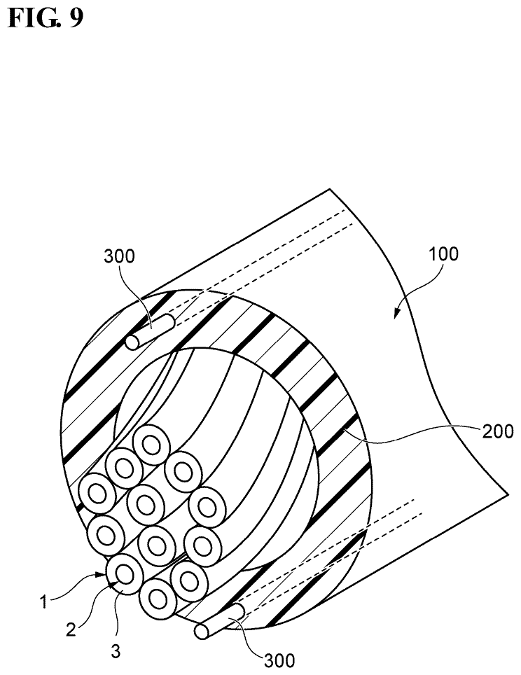

FIG. 8 is a diagram showing a cross section and a refractive index distribution orthogonal to a central axis of an MCF according to an embodiment. An MCF 1 according to the embodiment includes a glass fiber 2 and a resin coat 3 (see FIG. 9) covering an outer peripheral surface of the glass fiber 2. The glass fiber 2 has a central axis AX. The glass fiber 2 is made of silica-based glass. The glass fiber 2 has a plurality of cores 10 and a first cladding 20. In the present embodiment, the number of the plurality of cores 10 (the number of cores) is two, and the MCF 1 is a two-core optical fiber, but it is not limited thereto.

The plurality of cores 10 extends along the central axis AX of the glass fiber 2. The plurality of cores 10 has, for example, a circular shape in a cross section (hereinafter also referred to as “cross section”) orthogonal to the central axis AX. The plurality of cores 10 has, for example, the same circular shape in the cross section. Each diameter (core diameter) of the plurality of cores 10 is, for example, 4 μm to 15 μm, and may be 6 μm to 13 μm.

The plurality of cores 10 includes a first core 11 and a second core 12 that are closest to each other. In the cross section, a distance between a central position (central axis) of the first core 11 and a central position (central axis) of the second core 12 (core center-center distance) is, for example, 20 μm to 60 μm, and may be 30 μm to 50 μm. The first core 11 and the second core 12 have different effective refractive indices. A refractive index of the first core 11 and a refractive index of the second core 12 need not to be the same. The plurality of cores 10 is made of silica-based glass. The plurality of cores 10 may contain a dopant for adjusting the refractive index, or may be pure silica. The effective refractive index is obtained by, for example, measuring the refractive index distribution of the MCF 1 and calculating the effective refractive index from the measured refractive index distribution using the finite element method.

An inequality of 250×10⁻⁶≤n_eff1−n_eff2≤950×10⁻⁶ is satisfied, where n_eff1 is an effective refractive index of the first core 11 and n_eff2 is an effective refractive index of the second core 12. By setting “n_eff1−n_eff2” to 250×10⁻⁶ or more, the XT reduction effect can be sufficiently received. By setting “n_eff1−n_eff2” to 950×10⁻⁶ or less, the difference in cutoff wavelengths can be set to 100 nm or less. This makes it possible to improve mass productivity. An inequality of n_eff1−n_eff2≥400×10⁻⁶ may be satisfied. This further enhances the XT reduction effect.

When an MFD of the first core 11 is denoted by d1 and an MFD of the second core 12 is denoted by d2, “d1−d2” is −0.1 μm or less. This can reduce the difference in cutoff wavelengths between the first core 11 and the second core 12.

The “d1−d2” may be −0.15 μm or less, or may be −0.45 μm or less. This can further reduce the difference in cutoff wavelengths between the first core 11 and the second core 12.

The “d1−d2” may be −1.4 μm or more. This can reduce the connection loss when the MCFs 1 are connected to each other. The MFD is measured in accordance with, for example, 6.1 of ITU-T G650.1.

The first core 11 and the second core 12 are arranged in the cross section so as to face each other with the central axis AX interposed therebetween. The first core 11 and the second core 12 are arranged, for example, at equal distances from the central axis AX in the cross section.

The first cladding 20 surrounds the plurality of cores 10. The first cladding 20 is a common cladding that collectively surrounds the plurality of cores 10. A central axis of the first cladding 20 coincides with the central axis AX of the glass fiber 2. In the present embodiment, an outer peripheral surface of the first cladding 20 constitutes the outer peripheral surface of the glass fiber 2.

Inequalities of n11>n20 and n12>n20 are satisfied, where n11 is the refractive index of the first core 11, n12 is the refractive index of the second core 12, and n20 is a refractive index of the first cladding 20. In the present embodiment, an inequality of n11>n12 is satisfied. The first cladding 20 is made of silica-based glass. The first cladding 20 may contain a dopant for adjusting the refractive index, or may be pure silica.

FIG. 9 is a diagram showing an optical cable according to an embodiment. As shown in FIG. 9, an optical cable 100 according to the embodiment includes the plurality of MCFs 1 and an outer sheath 200. The outer sheath 200 forms a cylindrical accommodation space for accommodating the plurality of MCFs 1. The outer sheath 200 accommodates the plurality of MCFs 1 in the accommodation space. Two tension members 300 extending along a storage space are embedded in the outer sheath 200. Since the optical cable 100 includes the MCF 1, the optical cable 100 can satisfy the specifications of the cutoff and the bending loss simultaneously while reducing the XT.

Although the embodiments have been described, the present disclosure is not necessarily limited to the embodiments and variations described above, and various modifications are possible without departing from the gist thereof. Hereinafter, the modifications of the MCF 1 will be described while omitting the description of the same points as the MCF 1 as appropriate.

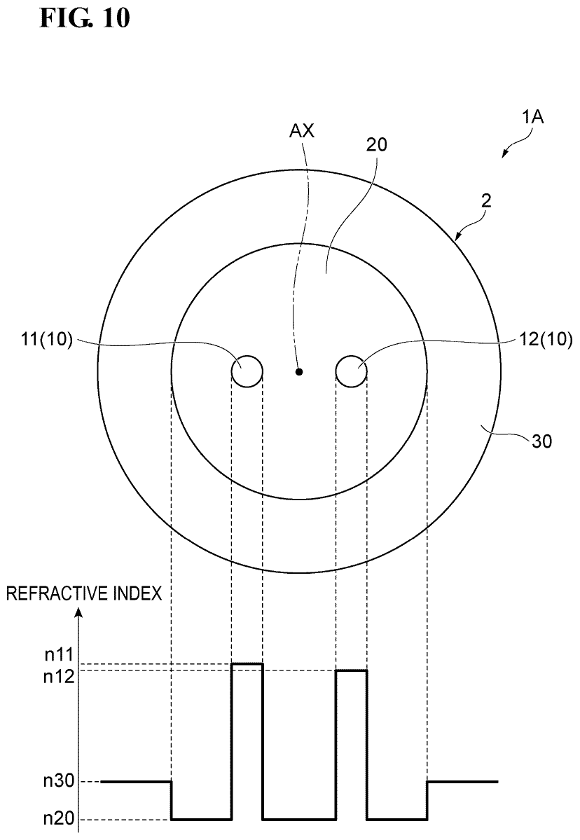

FIG. 10 is a diagram showing a cross section and a refractive index distribution orthogonal to a central axis of an MCF according to a first modification. In an MCF 1A according to the present modification, the glass fiber 2 further has a second cladding 30. The second cladding 30 surrounds the first cladding 20. The outer peripheral surface of the first cladding 20 is covered with the second cladding 30. An outer peripheral surface of the second cladding 30 constitutes the outer peripheral surface of the glass fiber 2. A refractive index of the second cladding 30 is higher than the refractive index of the first cladding 20 and lower than the effective refractive index of any of the plurality of cores 10. Inequalities of n11>n30>n20 and n12>n30>n20 are satisfied, where n30 is the refractive index of the second cladding 30. The second cladding 30 is made of silica-based glass and contains a dopant for adjusting the refractive index. The second cladding 30 provides an effect that the bending loss does not deteriorate even when the effective cross-sectional area of the core 10 is increased.

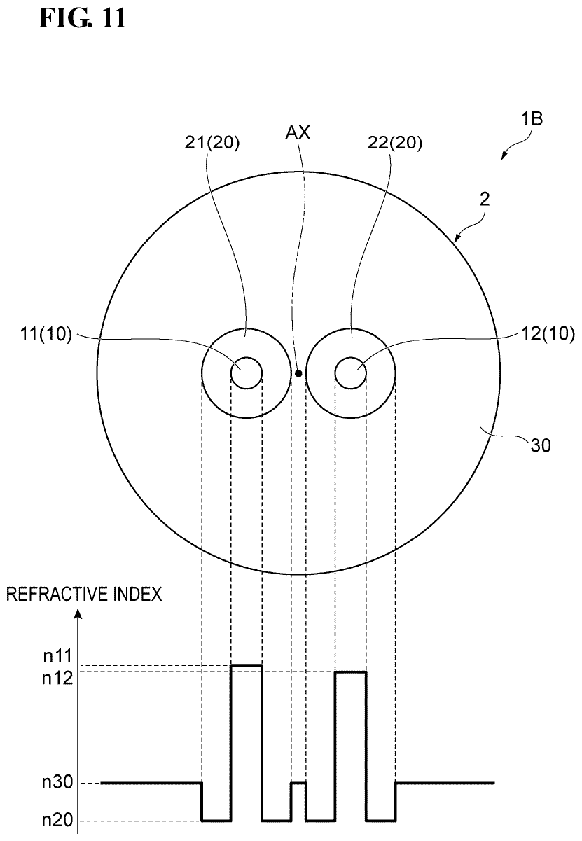

In the MCF 1A, since the first cladding 20 is common, the core 10 can be disposed closer to the central axis AX of the glass fiber 2 than in an MCF 1B (see FIG. 11) described later. Thus, when the MCFs 1A are connected to each other, the positional deviation due to the rotational deviation is reduced. Thus, the connection loss is reduced.

FIG. 11 is a diagram showing a cross section and a refractive index distribution orthogonal to a central axis of an MCF according to a second modification. In the MCF 1B according to the present modification, the glass fiber 2 further has the second cladding 30. The second cladding 30 surrounds the first cladding 20. The first cladding 20 includes a plurality of individual claddings 21 and 22 surrounding the plurality of cores 10, respectively. The number of the plurality of individual claddings 21 is equal to the number of the plurality of cores 10. In the present modification, the number of the plurality of individual claddings 21 is two. The individual cladding 21 surrounds the first core 11. The individual cladding 22 surrounds the second core 12.

The outer peripheral surfaces of the first claddings 20 (i.e., outer peripheral surfaces of the individual claddings 21 and 22) are covered with the second cladding 30. The outer peripheral surface of the second cladding 30 constitutes the outer peripheral surface of the glass fiber 2. The second cladding 30 is a common cladding that collectively surrounds the plurality of cores 10 together with the plurality of individual claddings 21 and 22.

The refractive index of the second cladding 30 is higher than the refractive index of the first cladding 20 and lower than the effective refractive index of any of the plurality of cores 10. Inequalities of n11>n30>n20 and n12>n30>n20 are satisfied, where n30 is the refractive index of the second cladding 30. The second cladding 30 is made of silica-based glass. The second cladding 30 may contain a dopant for adjusting the refractive index, or may be pure silica. The second cladding 30 provides an effect that the bending loss does not deteriorate even when the effective cross-sectional area of the core 10 is increased. In the MCF 1B, since the individual cladding 21, 22 is provided for each core 10, the first cladding 20 can be formed by a manufacturing method similar to that for a single-core optical fiber. Thus, the manufacturing cost can be reduced.

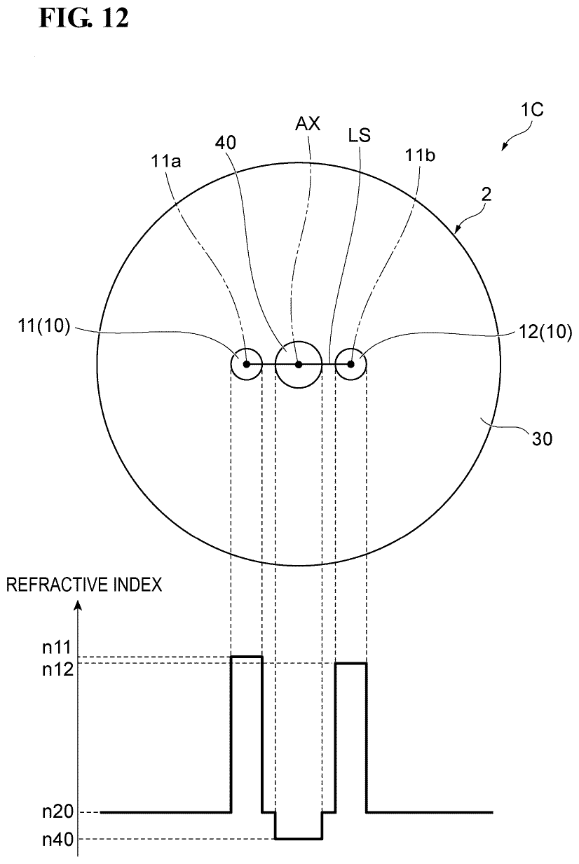

FIG. 12 is a diagram showing a cross section and a refractive index distribution orthogonal to a central axis of an MCF according to a third modification. In an MCF 1C according to the present modification, the glass fiber 2 further has a low-refractive-index portion 40. In this modification, the number of the low-refractive-index portions 40 is one. The low-refractive-index portion 40 is provided on a line segment LS connecting a core center 11a of the first core 11 to a core center 12a of the second core in the cross section.

The low-refractive-index portion 40 is disposed between the first core 11 and the second core 12 in the cross section. In the cross section, the low-refractive-index portion 40 has, for example, a circular shape, and the diameter of the low-refractive-index portion 40 is larger than the diameter of the core 10.

The low-refractive-index portion 40 has a refractive index lower than the refractive index of the first cladding 20. Inequalities of n11>n20>n40 and n12>n20>n40 are satisfied, where n40 is the refractive index of the low-refractive-index portion 40. In the MCF 1C, the low-refractive-index portion 40 can further reduce XT.

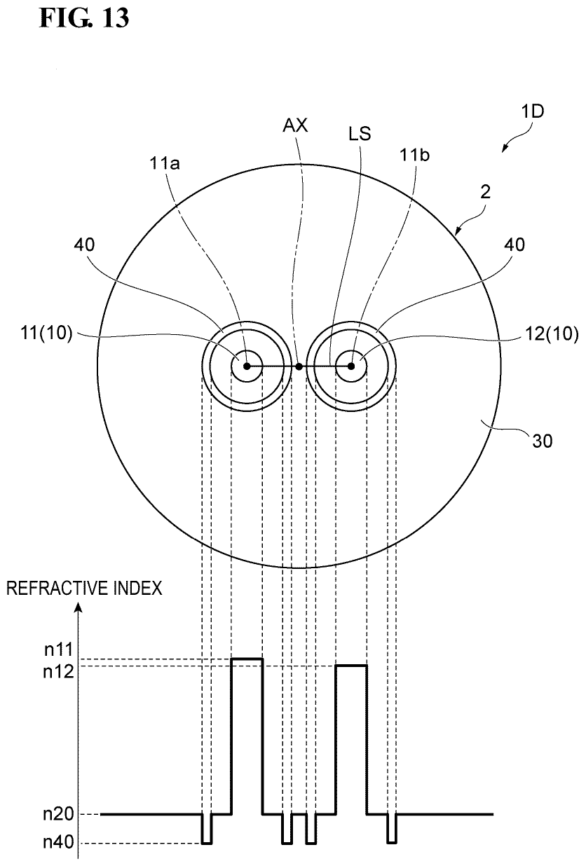

FIG. 13 is a diagram showing a cross section and a refractive index distribution orthogonal to a central axis of an MCF according to a fourth modification. In an MCF 1D according to the present modification, the glass fiber 2 further has the plurality of low-refractive-index portions 40. In the present modification, the number of low-refractive-index portions 40 is equal to the number of cores 10, which is two. The plurality of low-refractive-index portions 40 is provided on the line segment LS connecting the core center 11a of the first core 11 to the core center 12a of the second core in the cross section. The low-refractive-index portion 40 includes a portion disposed between the first core 11 and the second core 12 in the cross section.

In the cross section, the low-refractive-index portion 40 has, for example, an annular shape and surrounds one corresponding core 10. In the cross section, an inner diameter of the low-refractive-index portion 40 is larger than the diameter of the core 10, and the low-refractive-index portion 40 is spaced apart from the core 10 at equal intervals over the entire circumference. A central axis of the low-refractive-index portion 40 coincides with a central axis of the corresponding core 10. The low-refractive-index portion 40 is disposed so as to be coaxial with the corresponding core 10.

The low-refractive-index portion 40 has a refractive index lower than the refractive index of the first cladding 20. Inequalities of n11>n20>n40 and n12>n20>n40 are satisfied, where the refractive index of the low-refractive-index portion 40 is n40. In the MCF 1D, the low-refractive-index portion 40 can further reduce XT.

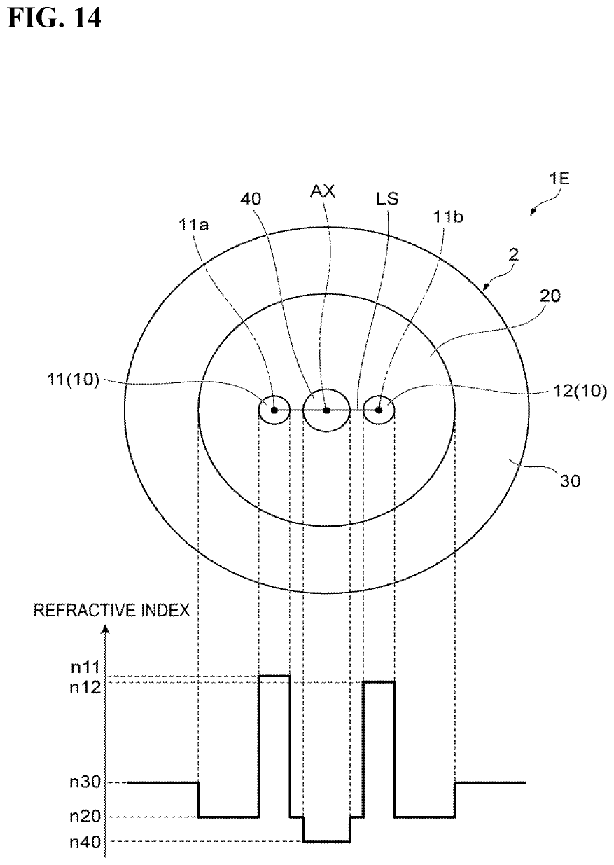

FIG. 14 is a diagram showing a cross section and a refractive index distribution orthogonal to a central axis of an MCF according to a fifth modification. The present modification corresponds to a combination of the first modification and the third modification. In an MCF 1E according to the present modification, the glass fiber 2 further has the second cladding 30 and the low-refractive-index portion 40. The second cladding 30 has a configuration similar to that of the second cladding 30 of the MCF 1A. The low-refractive-index portion 40 has a configuration similar to that of the low-refractive-index portion 40 of the MCF 1C. In the MCF 1E, the second cladding 30 provides an effect that the bending loss does not deteriorate even when the effective cross-sectional area of the core 10 is increased. Also, the low-refractive-index portion 40 can further reduce XT.

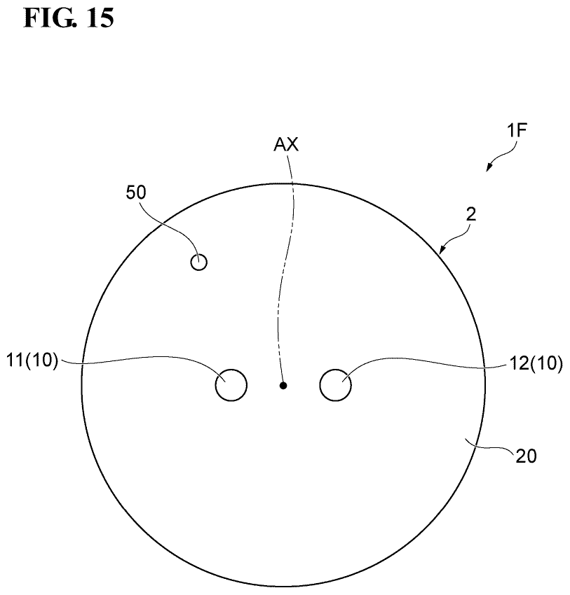

FIG. 15 is a diagram showing a cross section orthogonal to a central axis of an MCF according to a sixth modification. In an MCF 1F according to the present modification, the glass fiber 2 further has a marker 50. The marker 50 is surrounded by the first cladding 20. In the cross section, the marker 50 is disposed at a position where the symmetry (line symmetry, rotational symmetry, or the like) of the center positions of the plurality of cores 10 is broken. A refractive index of the marker 50 is different from the refractive index of the first cladding 20. According to the marker 50, even when the core arrangement has rotational symmetry, it is possible to identify the plurality of cores 10.

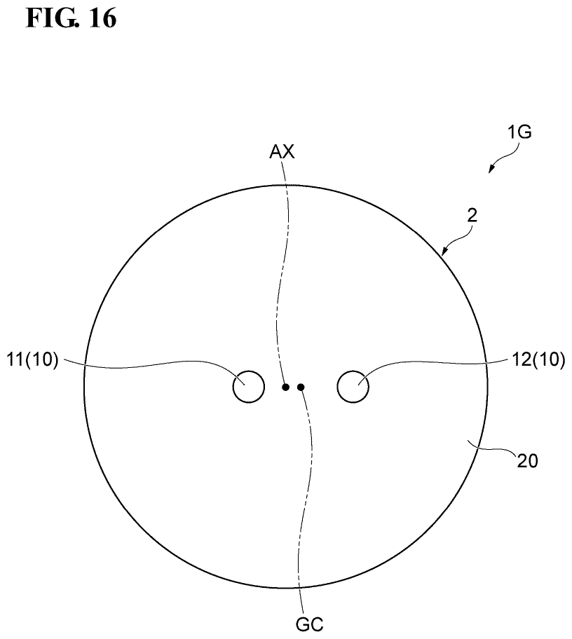

FIG. 16 is a diagram showing a cross section orthogonal to a central axis of an MCF according to a seventh modification. In an MCF 1G according to the present modification, in the cross section, the plurality of cores 10 is arranged such that a centroid GC of the plurality of cores 10 as a whole is shifted from the central axis AX. This eliminates rotational symmetry in the core arrangement, and thus enables identification of the plurality of cores 10.

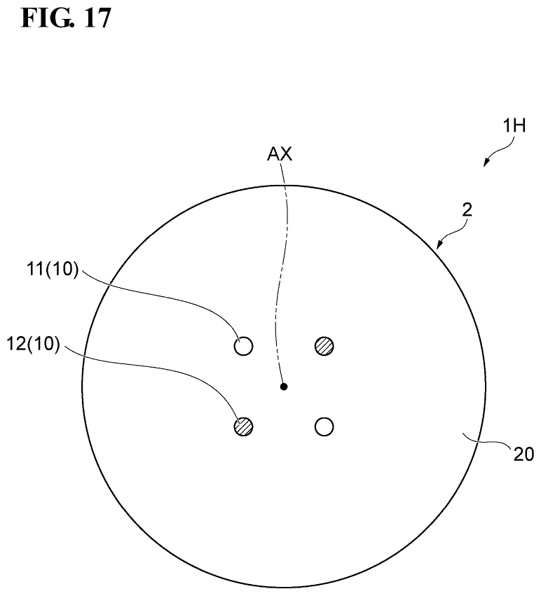

FIG. 17 is a diagram showing a cross section orthogonal to a central axis of an MCF according to an eighth modification. In an MCF 1H according to the present modification, the plurality of cores 10 is arranged in a square lattice pattern in the cross section. In this modification, the number of cores is four, and the MCF 1H is a four-core optical fiber. In the present modification, the plurality of cores 10 includes two first cores 11 and two second cores 12. In FIG. 17, the first core 11 is shown without hatching, and the second core 12 is shown with hatching. The plurality of cores 10 includes four combinations of adjacent cores. The plurality of cores 10 is arranged such that one of the adjacent cores is the first core 11 and the other is the second core 12 in all combinations of the adjacent cores. From the viewpoint of using different types of cores between adjacent cores, the core density can be increased while keeping XT low by arranging the plurality of cores 10 in a square lattice pattern. In a square lattice arrangement, all adjacent cores can be composed of different types of cores.

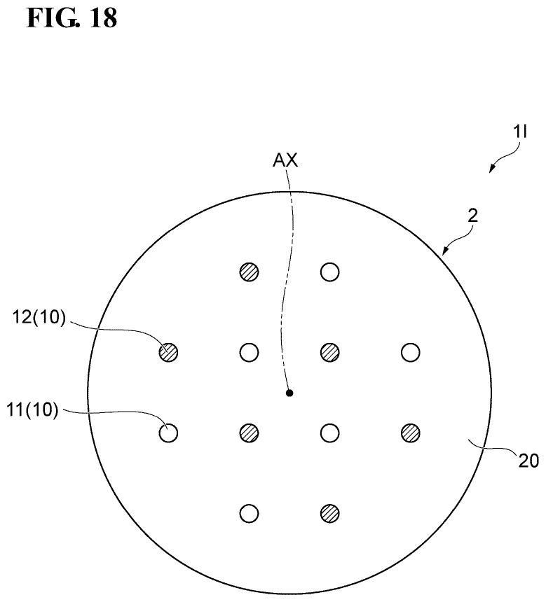

FIG. 18 is a diagram showing a cross section orthogonal to a central axis of an MCF according to a ninth modification. In an MCF 1I according to the present modification, the plurality of cores 10 is arranged in a square lattice pattern in the cross section. In this modification, the number of cores is 12, and the MCF 1I is a 12-core optical fiber. In the present modification, the plurality of cores 10 includes six first cores 11 and six second cores 12. In FIG. 16, the first core 11 is shown without hatching, and the second core 12 is shown with hatching. The plurality of cores 10 includes 16 combinations of adjacent cores. The plurality of cores 10 is arranged such that one of the adjacent cores is the first core 11 and the other is the second core 12 in all combinations of the adjacent cores. As in the MCF 1H, the core density can be increased while keeping XT low.

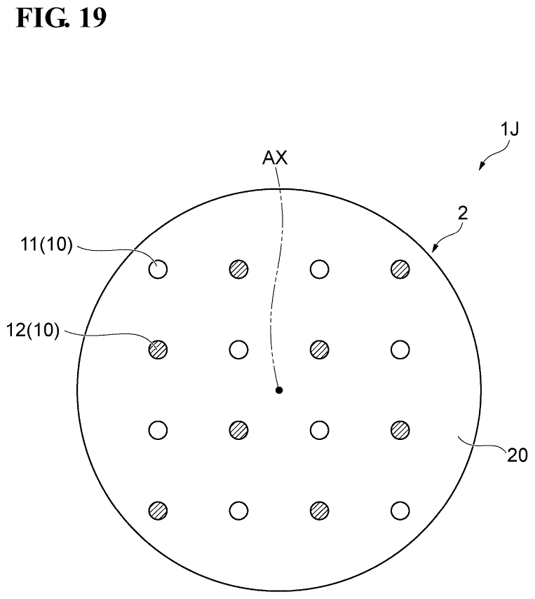

FIG. 19 is a diagram showing a cross section orthogonal to a central axis of an MCF according to a tenth modification. In an MCF 1J according to the present modification, the plurality of cores 10 is arranged in a square lattice pattern in the cross section. In the present modification, the number of cores is 16, and the MCF 1J is a 16-core optical fiber. In the present modification, the plurality of cores 10 includes eight first cores 11 and eight second cores 12. In FIG. 19, the first core 11 is shown without hatching, and the second core 12 is shown with hatching. The plurality of cores 10 includes 24 combinations of adjacent cores. The plurality of cores 10 is arranged such that one of the adjacent cores is the first core 11 and the other is the second core 12 in all combinations of the adjacent cores. As in the MCF 1H, the core density can be increased while keeping XT low.

The above embodiments and modifications may be combined as appropriate. For example, the optical cable 100 may include the MCF 1A instead of the MCF 1. The MCF 1 may be a 5-core optical fiber, and five cores 10 may be arranged in a cross shape. The MCF 1 may be a nine-core optical fiber, and nine cores 10 may be arranged in a 3×3 square lattice pattern. The second modification and the fourth modification may be combined.

### REFERENCE SIGNS LIST

1 1A, 1B, 1C, 1D, 1E, 1F, 1G, 1H, 1I, 1J MCF
2 glass fiber
3 resin coat
10 core
11 first core
11a core center
12 second core
12a core center
20 first cladding
21, 22 individual cladding
30 second cladding
40 low-refractive-index portion
50 marker
100 optical cable
200 outer sheath
300 tension member
AX central axis
GC centroid
LS line segment
n11 effective refractive index of first core
n12 effective refractive index of second core
n20 refractive index of first cladding
n30 refractive index of second cladding
n40 refractive index of low-refractive-index portion

What is claimed is:

1. A multicore optical fiber comprising:
a glass fiber,
wherein the glass fiber includes a plurality of cores extending along a central axis of the glass fiber and a first cladding surrounding the plurality of cores,
wherein the plurality of cores includes a first core and a second core that are closest to each other,
wherein an inequality of 250×10⁻⁶≤n1−n2≤950×10⁻⁶ is satisfied, where, at a wavelength that is at least one of wavelengths in a range of 1260 nm to 1625 nm, inclusive, n1 is an effective refractive index of the first core, and n2 is an effective refractive index of the second core, and
wherein an inequality of d1−d2≤−0.17 [μm] is satisfied, where d1 [μm] is a mode field diameter of the first core at the wavelength and d2 [μm] is a mode field diameter of the second core at the wavelength.

2. (canceled)

3. The multicore optical fiber according to claim 1,
wherein an inequality of d1−d2≤−0.45 [μm] is satisfied.

4. The multicore optical fiber according to claim 1,
wherein an inequality of d1−d2≥−1.4 [μm] is satisfied.

5. The multicore optical fiber according to claim 1,
wherein the plurality of cores is arranged in a square lattice pattern in a cross section orthogonal to the central axis.

6. The multicore optical fiber according to claim 1,
wherein the number of the plurality of cores is two.

7. The multicore optical fiber according to claim 5,
wherein the plurality of cores is arranged such that a centroid of the plurality of cores as a whole is shifted from the central axis in the cross section orthogonal to the central axis.

8. The multicore optical fiber according to claim 5,
wherein the glass fiber further includes a marker surrounded by the first cladding, and
wherein the marker has a refractive index different from a refractive index of the first cladding.

9. The multicore optical fiber according to claim 1,
wherein the glass fiber further includes a second cladding surrounding the first cladding, and
wherein the second cladding has a refractive index higher than the refractive index of the first cladding and lower than any of refractive indices of the plurality of cores.

10. The multicore optical fiber according to claim 9,
wherein the first cladding is a common cladding that collectively surrounds the plurality of cores.

11. The multicore optical fiber according to claim 9,
wherein the first cladding includes a plurality of individual claddings surrounding a respective one of the plurality of cores.

12. The multicore optical fiber according to claim 1,
wherein the glass fiber further includes a low-refractive-index portion having a refractive index lower than the refractive index of the first cladding, and
wherein the low-refractive-index portion is provided on a line segment connecting a central axis of the first core to a central axis of the second core in the cross section orthogonal to the central axis.

13. An optical cable comprising:
a plurality of multicore optical fibers according to claim 1; and
an outer sheath that accommodates the plurality of multi-core optical fibers.
